(19) United States
(12) Patent Application Publication
(10) Pub. No.: US 2004/0189684 A1
(43) Pub. Date: Sep. 30, 2004

(54) Method and apparatus for guiding a less experienced user

(76) Inventors: Eric Edwards, San Jose, CA (US); Ali Tabatabai, Cupertino, CA (US)

Correspondence Address: Valley Oak Law, #106, 5655 Silver Creek Valley Road, San Jose, CA, 95138, US

(21) Appl. No.: 10/403,639

(22) Filed: Mar. 31, 2003

(51) Int. Cl. G09G 5/00

(52) U.S. Cl. 345/707

(57) ABSTRACT

The invention illustrates a system and method of assisting a less experienced user with the operation of a networked device. In one embodiment, the system and method comprises: creating a customized guide wherein the customized guide is configured for a less experienced user; transmitting the customization guide to the less experienced user; and utilizing the customized guide via the less experienced user wherein the customized guide includes a function and a corresponding customization option. Other aspects and advantages of the invention will become apparent from the following detailed description, taken in conjunction with the accompanying drawings, illustrated by way of example of the principles of the invention.

### FIELD OF THE INVENTION

The present invention relates generally to providing assistance to a less experienced user and, more particularly, to providing assistance to a less experienced user while using a networked device.

### BACKGROUND OF THE INVENTION

There has been an increased use of computers both for personal use and business use. With the prices of computers decreasing, more people have access to computers. With the increased use of computers, access to the Internet has also proliferated.

Even with the increased use of computers and the Internet, many people are still not familiar with the use of applications on a computer and applications accessible through the Internet. For example, for those not familiar with computers, saving a file within a word processor application or accessing a photo within a photo album stored within a web site may not be possible.

### SUMMARY OF THE INVENTION

The invention illustrates a system and method of assisting a less experienced user with the operation of a networked device. In one embodiment, the system and method comprises: creating a customized guide wherein the customized guide is configured for a less experienced user; transmitting the customization guide to the less experienced user; and utilizing the customized guide via the less experienced user wherein the customized guide includes a function and a corresponding customization option.

Other aspects and advantages of the invention will become apparent from the following detailed description, taken in conjunction with the accompanying drawings, illustrated by way of example of the principles of the invention.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1 is a diagram illustrating an environment within which the invention may be implemented.

FIG. 2 is a simplified block diagram illustrating one embodiment in which the invention may be implemented.

FIG. 3 is a simplified block diagram illustrating a system, consistent with one embodiment of the invention.

FIG. 4 is a flow diagram consistent with one embodiment of the invention.

FIG. 5 is a flow diagram consistent with one embodiment of the invention.

FIG. 6 is a screen shot illustrating one aspect of programming a customized guide consistent with one embodiment of the invention.

FIG. 7 is a screen shot illustrating one aspect of programming a customized guide consistent with one embodiment of the invention.

FIG. 8 is a screen shot illustrating one aspect of programming a customized guide consistent with one embodiment of the invention.

FIG. 9 is a screen shot illustrating one aspect of programming a customized guide consistent with one embodiment of the invention.

FIG. 10 is a screen shot illustrating one aspect of utilizing a customized guide consistent with one embodiment of the invention.

FIG. 11 is a screen shot illustrating one aspect of utilizing a customized guide consistent with one embodiment of the invention.

FIG. 12 is a screen shot illustrating one aspect of utilizing a customized guide consistent with one embodiment of the invention.

FIG. 13 is a screen shot illustrating one aspect of utilizing a customized guide consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The invention includes methods and apparatus for assisting a less experienced in operating applications on their computers. The invention also includes methods and apparatus for “programming” customized functions that assist a less experienced user in utilizing a computer application. The invention allows a more experienced user to form a customized application or applet to assist the less experienced user in performing a specific task on another computer or networked device while interacting with a website, an email application, or a local application. This application or applet could be as simple set of instructions for the less experienced user, or several buttons linked to customized subroutines that execute predetermined tasks on the computer, a website or other device which is operated by the less experienced user. In addition, the customized subroutines may also automatically perform functions on the computer or device operated by the less experienced user without any user intervention by the less experienced user.

Those skilled in the art will recognize that many other implementations are possible, consistent with the present invention.

A. Environment and Architecture

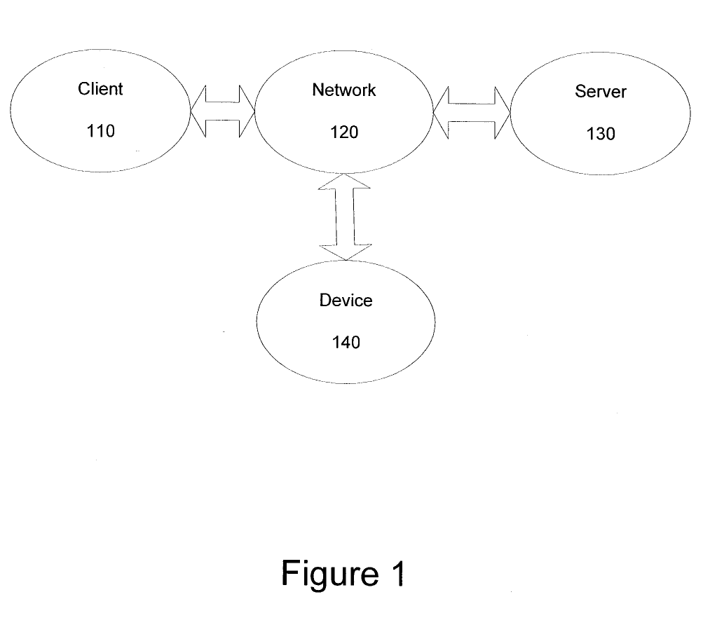

FIG. 1 is a diagram illustrating an environment within which the invention may be implemented. The environment includes a client 110, a network 120, a server 130, and a device 140.

The client 110 may be a consumer electronics device. The consumer electronics device may include a computer, a digital camera, a telephone, a pager, and the like. In one embodiment, the client 110 may be configured to be utilized by a less experienced user. The less experienced user may not possess the skills to sufficiently operate a computer application and may need guidance to complete specific operations of the computer application.

The device 140 may be a consumer electronics device. The consumer electronics device may include a computer, a digital camera, a telephone, a pager, and the like. In one embodiment, the device 140 may be configured to be utilized by a more experienced user. The more experienced user may possess enough skills to utilize the invention to assist the less experienced user.

The network 120 interfaces with the client 110, the device 140, and the server 130. In one embodiment, the network 120 is the Internet. In another embodiment, the network 120 may be any transmission medium between the client 110 and the server 130.

The sever 130 is a device configured to interface with the client 110 and the device 140 through the network 120.

The client 110, the device 140, and/or the server 130 may include a combination of software, hardware, and/or firmware to provide functionality for the invention.

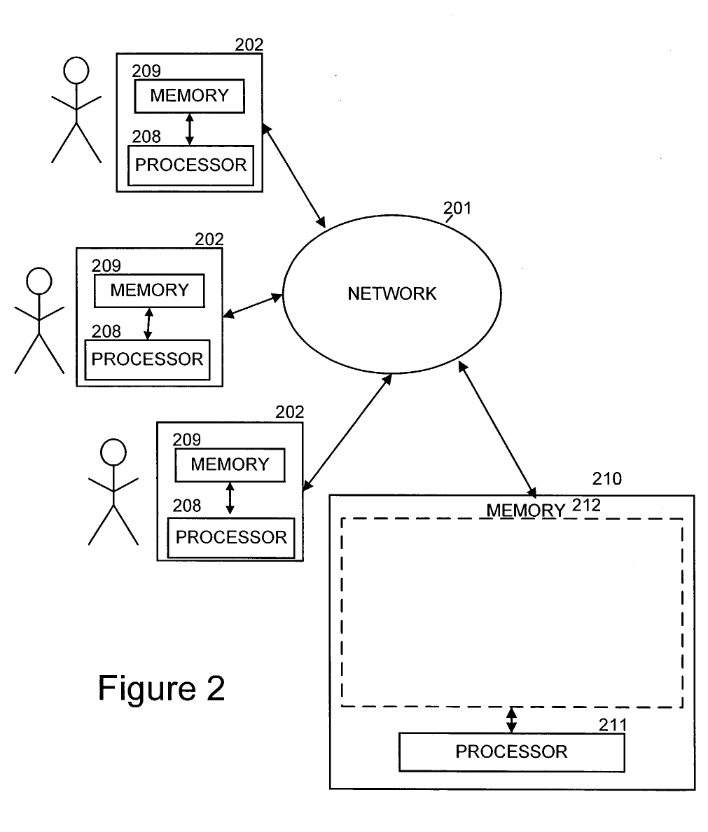

FIG. 2 is a simplified diagram illustrating an exemplary architecture in which the present invention may be implemented. The exemplary architecture includes a plurality of client devices 202, a server device 210, and a network 201. In one embodiment, the network 201 may be the Internet. The plurality of client devices 202 are each configured to include a computer-readable medium 209, such as random access memory, coupled to a processor 208. Processor 208 executes program instructions stored in the computer-readable medium 209. In another embodiment, the plurality of client devices 202 may also include a number of additional external or internal devices, such as, without limitation, a mouse, a CD-ROM, a keyboard, and a display.

The interface framework may be stored on the plurality of client devices 202 within each computer-readable medium 209.

Similar to the plurality of client devices 202, the server device 210 may include a processor 211 coupled to a computer-readable medium 212. The server device 210 may also include a number of additional external or internal devices, such as, without limitation, a secondary storage element, such as database 240.

The interface framework may be stored on the server device 210 within each computer-readable medium 212.

The plurality of client processors 208 and the server processor 211 can be any of a number of well known computer processors, such as processors from Intel Corporation, of Santa Clara, Calif. In general, the plurality of client devices 202 may be any type of computing platform connected to a network and that interacts with application programs, such as a digital assistant or a “smart” cellular telephone or pager. The server 210, although depicted as a single computer system, may be implemented as a network of computer processors.

The plurality of client devices 202 and the server 210 may include the interface framework. In one embodiment, the plurality of computer-readable medium 209 and 212 may contain, in part, the interface framework. Additionally, the plurality of client devices 202 and the server 210 are configured to receive and transmit information for use with the interface framework. Similarly, the network 201 is configured to transmit information for use with the invention.

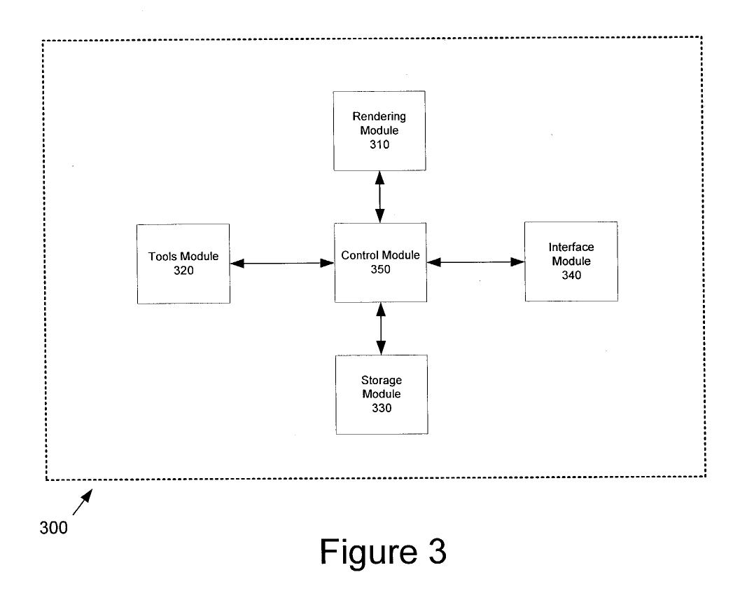

FIG. 3 illustrates one embodiment of a computer application guidance system 300. The guidance system 300 includes a rendering module 310, a tools module 320, a storage module 330, an interface module 340, and a control module 350. In one embodiment, the control module 350 is configured to communicate with the rendering module 310, the tools module 320, the storage module 330, and the interface module 340.

In one embodiment, the control module 350 is configured to coordinate tasks, requests and communications between the rendering module 310, the tools module 320, the storage module 330, and the interface module 340.

In one embodiment, the rendering module 310 is configured to render an image based on screen image data. In one embodiment, the screen image data may be stored within the storage module 330. For example, the screen image data is visually shown in subsequent screen shots.

In one embodiment, the tools module 320 is configured to allow the more experienced user to customize a specific guide for a less experienced user. For example, the guide may assist the less experienced user in utilizing functions of a computer application. The guide may assist the less experienced user in functions such as accessing a particular photo album, selecting a particular picture within the photo album, saving the particular picture to a specific folder within the less experienced user's computer, and the like.

In one embodiment, the tools module 320 facilitates the creation of the guide to be utilized by the less experienced user. In one embodiment, the tools module 320 may utilized predefined functions such as “save as”, “new file”, “find”, and the like. In another embodiment, the tools module 320 may customize these predefined functions.

In one embodiment, the storage module 330 is configured for storing data. This data may include the customized guides, predefined functions, customized predefined functions, and the like.

In one embodiment, the interface module 340 is configured to receive less experienced user instructions to operate the system 300. In one embodiment, the interface module 340 is configured to receive more experienced user instructions to customize a guide to operate the system 300.

In one embodiment, the system 300 is integrated within the particular computer application. In another embodiment, the system 300 is separate from the particular computer application.

In one embodiment, the interface module 340 is configured to provide a customized guide to the less experienced user. In one embodiment, the customized guide helps the less experienced userl to operate a computer application such as performing various functions within a computer application. In one embodiment, the interface module 340 is configured to communicate with the more experienced user to create a customized guide for a specific less experienced user.

The system 300 in FIG. 3 is shown for exemplary purposes and is merely embodiment of the invention. Additional modules may be added to the system 300 without departing from the scope of the invention. Similarly, modules may be combined or deleted without departing from the scope of the invention.

B. Operation

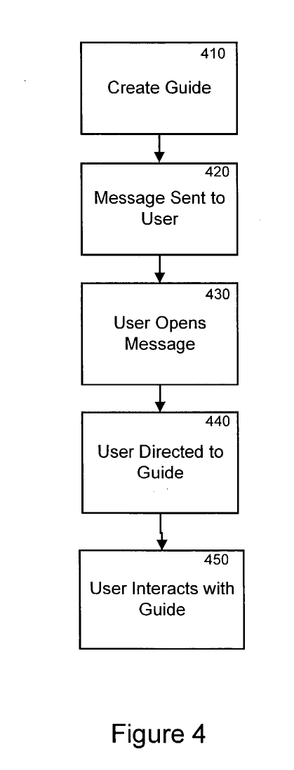

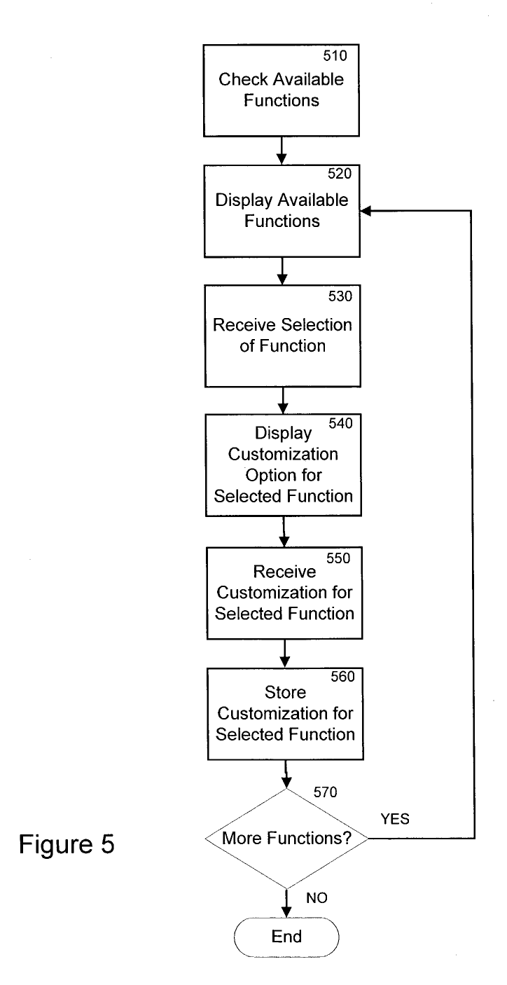

The flow diagrams as depicted in FIGS. 4 and 5 are merely one embodiment of the invention. The blocks within the flow diagrams may be performed in a different sequence without departing from the spirit of the invention. Further, blocks may be deleted, added, or combined without departing from the spirit of the invention.

The flow diagram in FIG. 4 illustrates a simplified interaction between the more experienced user, the less experienced user, and the system according to one embodiment of the invention.

In Block 410, a customized guide is created for assisting the less experienced user in utilizing a computer application. In one embodiment, the customized guide is customized for a particular computer application. In another embodiment, the customized guide is customized for a particular less experienced user. The customized guide may provide the less experienced user with an interactive format to assist the less experienced user.

The customized guide may be created by the more experienced user using various tools within the system 300 (FIG. 3). For example, the customized guide may be created by utilizing the rendering module 310, the tools module 320, the storage module 330, the interface module 340, and/or the control module 350.

In one embodiment, the system 300 is configured to allow a more experienced user without any specialized computer knowledge to create the customized guide. For example, if the more experienced user can operate the computer program, the more experienced user is capable of creating the customized guide for the less experienced user.

In Block 420, a message is sent to the less experienced user. The message may include the customized guide created for the less experienced user. The message may be in the form of electronic mail, a proprietary message system such as Yahoo Messenger™, and the like.

In Block 430, the less experienced user opens the message.

In Block 440, the less experienced user is directed to the guide. In one embodiment, the message may be self-contained and include the guide within the message. In another embodiment, the message may provide a link to the customized guide which is not included within the message and stored in a remote location. For example, the message may include a URL link to the customized guide.

In Block 450, the less experienced user interacts with the customized guide.

The flow diagram in FIG. 5 illustrates creating a customized guide according to one embodiment of the invention.

In Block 510, an assessment of the available functions in creating the customized guide. Sample functions include: “save as”, “view selected images”, “send selected documents”, “annotate selected images”, and the like. The specific functions available may depend on the specific computer application that is utilized. For example, a photo album application may have specific functions that are unique to handling electronic images while a music swapping application may have specific functions that are unique to exchanging and storing music files.

In one embodiment, the available functions are stored in the tools module 320. In another embodiment, the available functions are stored in the storage module 330.

In Block 520, the available functions are displayed to the more experienced user. In one embodiment, the available functions are displayed via the rendering module 310.

In Block 530, the more experienced user selects one of the available functions.

In Block 540, a customization option is displayed for the selected function. In one embodiment, the customization option allows the selected function to be customized for the particular less experienced user. For example, selecting the particular images may be a customization option for a function of “sending images”. Further, specifying the recipient of the images may also be another customization option of “sending images”.

In Block 550, the specific customization option is received by the system 300.

In Block 560, the specific customization option is stored. In one embodiment, the specific customization is stored for a particular less experienced user. For example, the customization may be configured for a specific less experienced user.

In one embodiment, the specific customization may be stored within the storage module 330. In another embodiment, the specific customization may be stored in a remote location.

In Block 570, if there are additional functions that the more experienced user would like to select, then the process returns to the Block 520 and displays the available function(s).

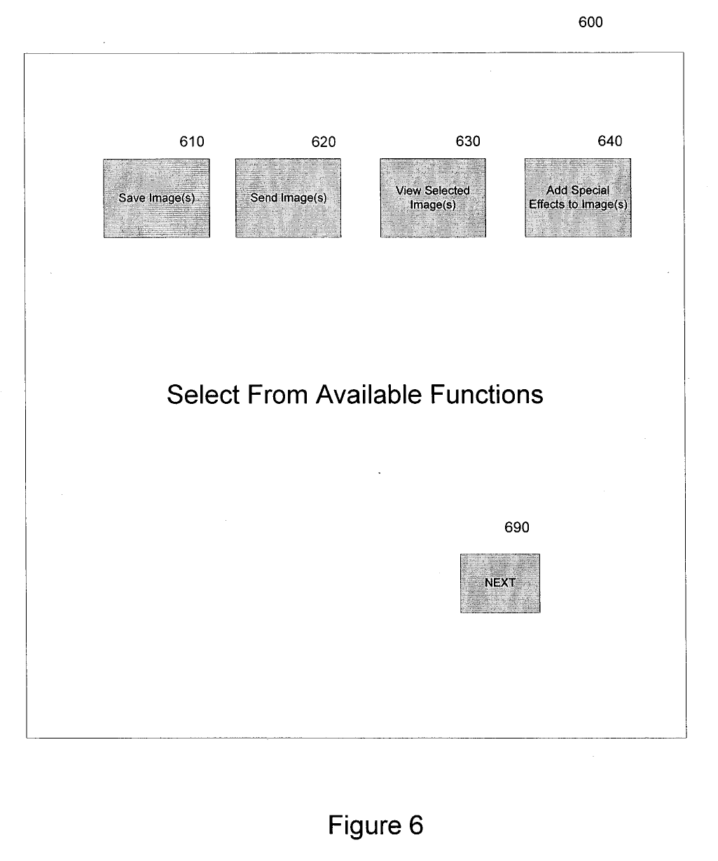

FIGS. 6-9 are a sequence of screen shots which illustrate programming a guide for a less experienced user according to one embodiment of the invention. This sequence of screen shots is shown for exemplary purposes and is not intended to limit the scope of the invention.

The sequence of screen shots illustrate an exemplary interface between the more experienced user and the customized guide. In other embodiments, different interfaces may be utilized such as Windows™, Mac™, and other proprietary standards.

FIG. 6 shows a sample screen shot 600 illustrating programming a customized guide for operation by a less experienced user according to one embodiment of the invention. The screen shot 600 is configured to allow the more experienced user to select from a plurality of functions such as save image(s) 610, send image(s) 620, view selected image(s) 630, and add special effects to image(s) 640.

The plurality of functions are customized in response to the type of computer application that the customized guide is to be utilized in conjunction with. For example, the particular customized guide being programmed within the FIGS. 6-9, is configured to be utilized in conjunction with a photo album computer application. In other embodiments, a variety of computer applications may be utilized with a corresponding unique customized guide.

In one embodiment, the plurality of functions in the screen shot 600 corresponds with the display of functions in the Block 520.

In one embodiment, a next button 690 is displayed after the more experienced user is finished with the selections on the screen shot 600.

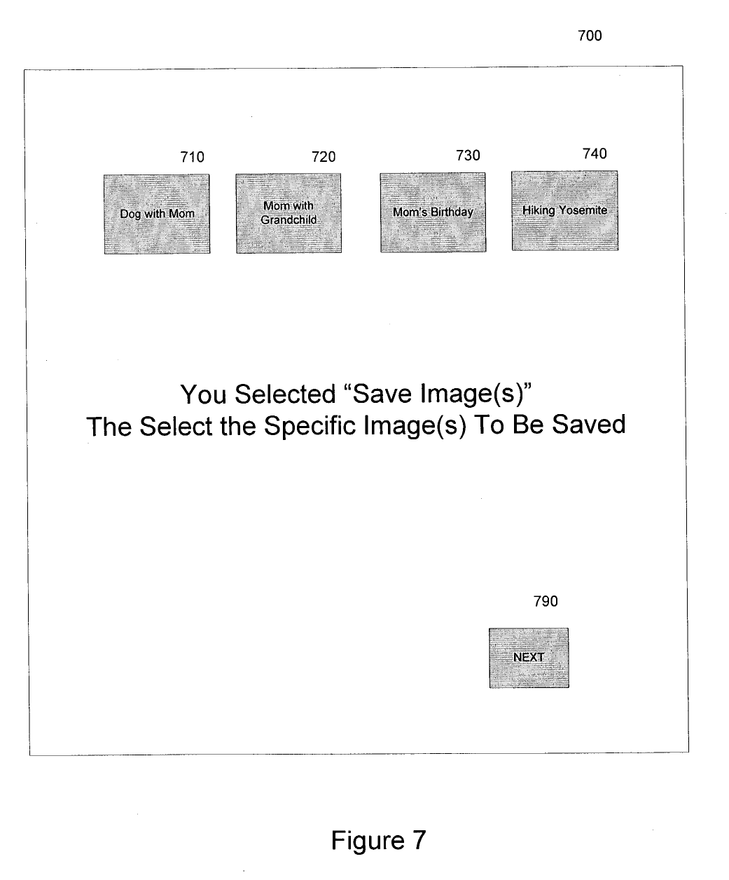

FIG. 7 shows a sample screen shot 700 illustrating programming a customized guide for operation by a less experienced user according to one embodiment of the invention. The screen shot 700 indicates that the more experienced user previously selected “Save Image(s)” as the desired function on a prior screen. The screen shot 700 is configured to allow the more experienced user to select specific image(s) to be saved.

The screen shot 700 displays an image 710, an image 720, an image 730, and an image 740 available to be saved. In one embodiment, the actual thumbnail image may be displayed. In another embodiment, the actual thumbnail image with a text description may be displayed. In yet another embodiment, a brief text description of the image may be displayed.

In one embodiment, a next button 790 is displayed after the more experienced user is finished with the selections on the screen shot 700.

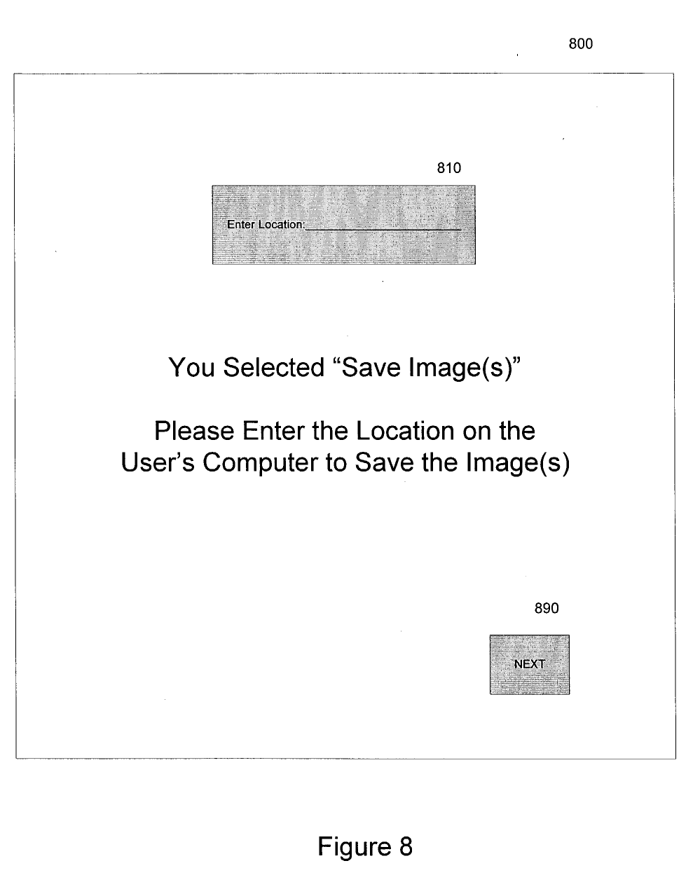

FIG. 8 shows a sample screen shot 800 illustrating programming a customized guide for operation by a less experienced user according to one embodiment of the invention. The screen shot 800 indicates that the more experienced user previously selected “Save Image(s)” as the desired function on a prior screen. The screen shot 800 is configured to allow the more experienced user to enter a specific location in a box 810 for the image(s) to be saved. In one embodiment, the location may be on the less experienced user's computer. In another embodiment, the location may be on a remote location. For example, the remote location may reside on a photo album account belonging to the less experienced user and residing on a remote server.

In one embodiment, a next button 890 is displayed after the more experienced user is finished with the selections on the screen shot 800.

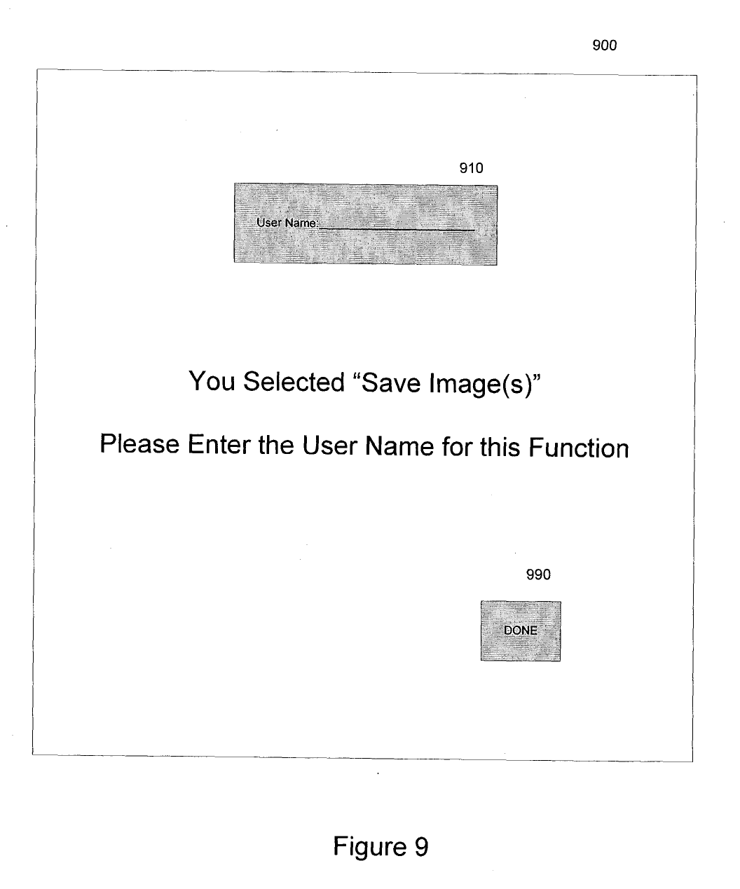

FIG. 9 shows a sample screen shot 900 illustrating programming a customized guide for operation by a less experienced user according to one embodiment of the invention. The screen shot 900 indicates that the more experienced user previously selected “Save Image(s)” as the desired function on a prior screen. The screen shot 900 is configured to allow the more experienced user to enter a specific less experienced user in a box 910 for the image(s) to be saved. In one embodiment, the specific less experienced user may already have their profile information previously stored. The profile information may include the email address other personal contact information belonging to the less experienced user. In another embodiment, the more experienced user may provide the email address of the less experienced user.

In one embodiment, a done button 990 is displayed after the more experienced user is finished with the selections on the screen shot 900.

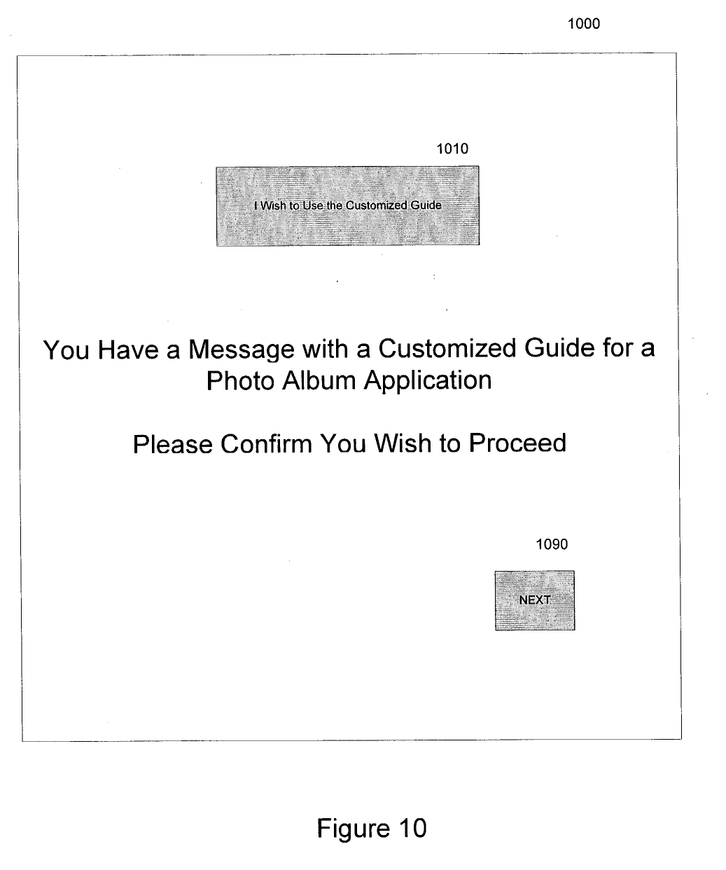

FIGS. 10-13 are a sequence of screen shots which illustrate a less experienced user using a guide setup by a more experienced user according to one embodiment of the invention. This sequence of screen shots is shown for exemplary purposes and is not intended to limit the scope of the invention.

The sequence of screen shots illustrate an exemplary interface between the less experienced user and the customized guide. In other embodiments, different interfaces may be utilized such as Windows™, Mac™, and other proprietary standards.

In addition, the interface between the less experienced user and the customized guide may be animated to show the operation of the customized guide without input from the less experienced user in one embodiment. For example, a cursor may be shown moving within the screen and making specific selections through a standardized interface without input from the less experienced user. This may be accomplished through the customized guide.

FIG. 10 shows a sample screen shot 1000 illustrating utilizing a customized guide for operation by a less experienced user according to one embodiment of the invention. The screen shot 1000 indicates that the less experienced user has a message that a customized guide has been configured for the less experienced user for a photo album application. The particular customized guide being utilized within the FIGS. 10-13, is configured to be utilized in conjunction with a photo album computer application. In other embodiments, a variety of computer applications may be utilized with a corresponding unique customized guide.

To proceed with utilizing the customized guide, the less experienced user may select a confirmation button 1010. In one embodiment, the customized guide is within the message. For example, the customized guide may be contained within the message and initiated from less experienced user's response. In another embodiment, the customized guide is stored in a remote location and may be accessed from the remote location through a URL.

In one embodiment, a next button 1090 is displayed after the more experienced user is finished with the selections on the screen shot 1000.

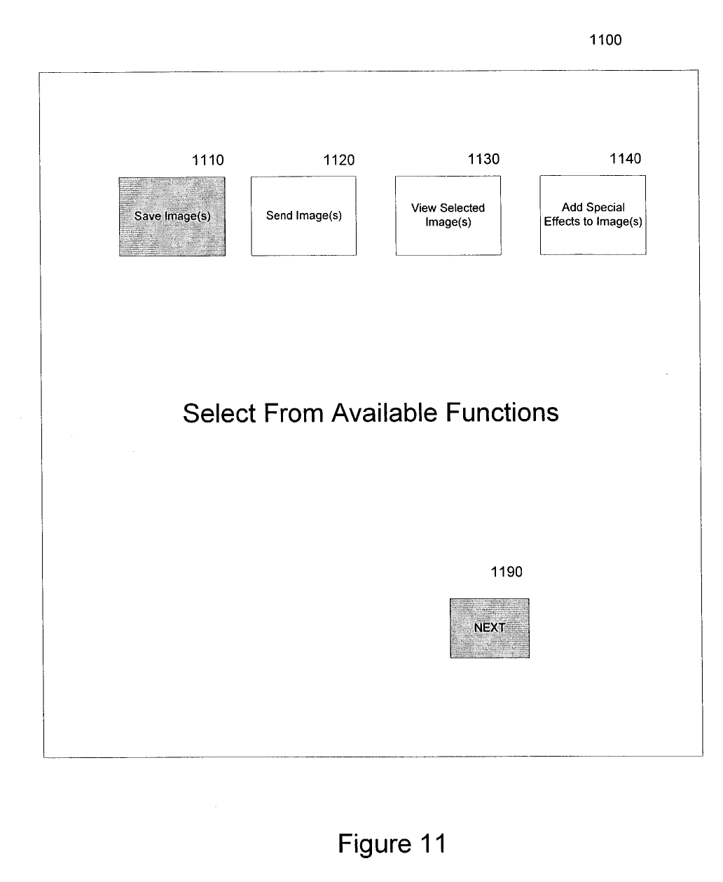

FIG. 11 shows a sample screen shot 1100 illustrating utilizing a customized guide for operation by a less experienced user according to one embodiment of the invention. The screen shot 1100 displays a plurality of functions such as save image(s) 1110, send image(s) 1120, view selected image(s) 1130, and add special effects 1140.

In one embodiment, the plurality of functions represent the functions which were available to the more experienced user when creating the customized guide. For example, all the functions save image(s) 1110, send image(s) 1120, view selected image(s) 1130, and add special effects 1140 are shown because they were available to the more experienced user at the time the customized guide was created. In one embodiment, the shaded function 1110 (“save image(s)”) indicates that the particular customized guide is programmed to allow the less experienced user to select the shaded function 1110.

In one embodiment, the shaded function 1110 is available to be selected by the less experienced user.

In another embodiment, only the functions which the more experienced user selected for the customized guide are displayed. For example, only the functions which are available to the less experienced user are displayed.

In one embodiment, a next button 1190 is displayed after the more experienced user is finished with the selections on the screen shot 1100.

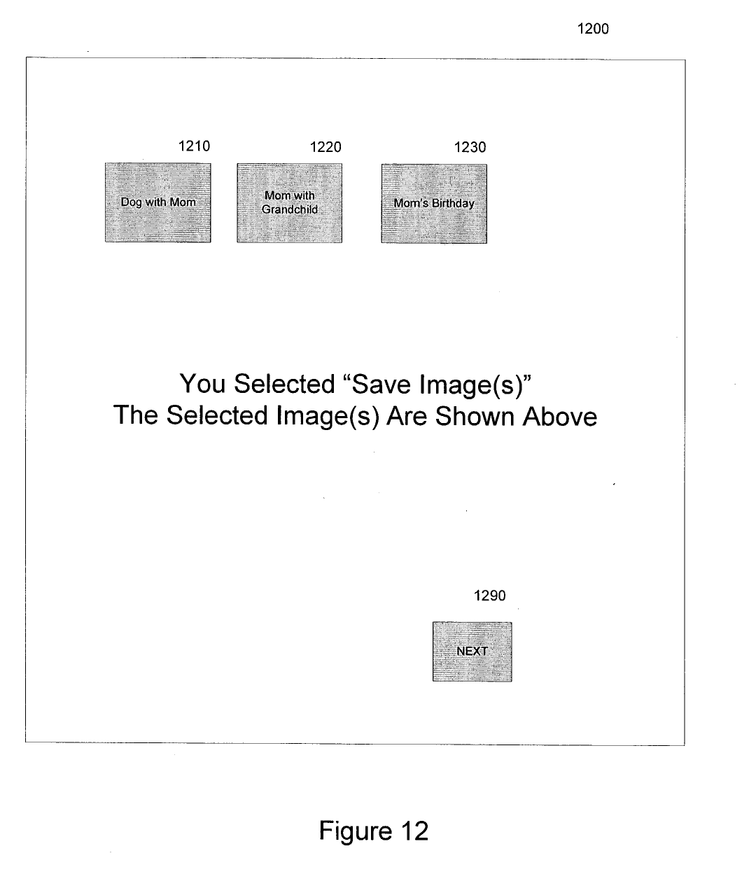

FIG. 12 shows a sample screen shot 1200 illustrating utilizing a customized guide for operation by a less experienced user according to one embodiment of the invention. The screen shot 1200 indicates that the less experienced user previously selected “Save Image(s)” as the desired function on a prior screen. The screen shot 1200 is configured to allow show the less experienced user specific images which were previously selected by the more experienced user. For example, images 1210, 1220, and 1230 are shown in the screen shot 1200. The images 1210, 1220, and 1230 correspond with the images 710, 720, and 730, respectively. The image 740 (FIG. 7) was not chosen by the more experienced user and was not included with the customized guide. Accordingly, the image 740 is not displayed for the less experienced user within the screen shot 1200.

In one embodiment, the images 1210, 1220, and 1230 are shown as actual images in thumbnail form. In another embodiment, the images 1210, 1220, and 1230 are shown as a text description. In yet another embodiment, the images 1210, 1220, and 1230 are shown with a combination text description and thumbnail form.

In one embodiment, the less experienced user may select to view any of the images 1210, 1220, and 1230 in an enlarged view.

In one embodiment, a next button 1290 is displayed after the more experienced user is finished with the selections on the screen shot 1200.

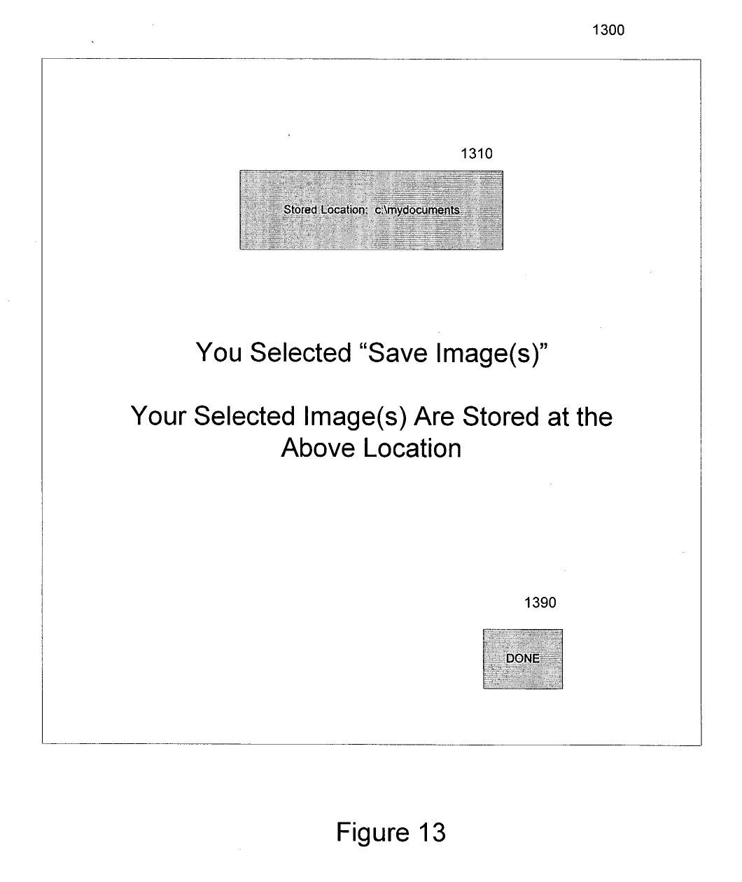

FIG. 13 shows a sample screen shot 1300 illustrating utilizing a customized guide for operation by a less experienced user according to one embodiment of the invention. The screen shot 1300 indicates that the less experienced user previously selected “Save Image(s)” as the desired function on a prior screen. The screen shot 1300 is configured to allow show the less experienced user the storage location for specific images which were previously selected by the more experienced user. For example, a box 1310 displays the location where the selected images are to be stored. The location within the box 1310 has been selected by the more experienced user when creating the customized guide for the less experienced user.

In one embodiment, the less experienced user may select a different storage location for the selected images.

In one embodiment, a done button 1390 is displayed after the less experienced user is finished with the selections on the screen shot 1300.

C. Conclusion

The foregoing descriptions of specific embodiments of the invention have been presented for purposes of illustration and description. For example, the invention is described within the context of creating customized guides for assisting less experienced users in utilizing computer applications as merely one embodiment of the invention. The customized guide is shown within the context of a photo album application. However, the invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
creating a customized guide wherein the customized guide is configured for a less experienced user;
transmitting the customization guide to the less experienced user;
and
utilizing the customized guide via the less experienced user wherein the customized guide includes a function and a corresponding customization option.

2. The method according to claim 1 further comprising sending a message to the less experienced user.

3. The method according to claim 2 wherein the message includes the customized guide.

4. The method according to claim 2 wherein the message includes a link to the customized guide.

5. The method according to claim 1 wherein the function includes one of a save as function, a transmit an image function, a view selected image function, and an add a special effects function.

6. The method according to claim 1 further comprising storing the customized guide.

7. The method according to claim 1 wherein the corresponding customization option relates to a pre-decided choice for the less experienced user relating to the function.

8. The method according to claim 1 wherein the corresponding customization includes one of saving content to a location, selecting specific content, and sending content to an address.

9. A method comprising:
selecting a computer application;
viewing an available function based on the computer application;
selecting a selected function from the available function; and
storing a customization option corresponding to the selected function.

10. The method according to claim 9 wherein the computer application is a web-site based application.

11. The method according to claim 10 wherein the computer application is an on-line photo album.

12. The method according to claim 9 further comprising identifying a less experienced user for the customization option.

13. The method according to claim 9 further comprising storing the selected function and the customization option within a customized guide for a less experienced user.

14. The method according to claim 9 further comprising identifying a less experienced user for the customization option.

15. A system, comprising:
a tools module configured for coordinating a function and a corresponding customization option and for creating a customized guide for a less experienced user; and
a storage module configured for storing the function and the corresponding customization option.

16. The system according to claim 15 wherein the function includes one of a save as function, a transmit an image function, a view selected image function, and an add a special effects function.

17. The device according to claim 15 wherein the function is based on a specific computer application.

18. The device according to claim 15 further comprising an interface module configured to allow a more experienced user to select the function and corresponding customization option.

19. A computer-readable medium having computer executable instructions for performing a method comprising:
creating a customized guide wherein the customized guide is configured for a less experienced user;
transmitting the customization guide to the less experienced user; and
utilizing the customized guide via the less experienced user wherein the customized guide includes a function and a corresponding customization option.

20. A system comprising:
means for creating a customized guide wherein the customized guide is configured for a less experienced user;
means for transmitting the customization guide to the less experienced user; and
means for utilizing the customized guide via the less experienced user wherein the customized guide includes a function and a corresponding customization option.
